(19) United States
(12) Patent Application Publication
(10) Pub. No.: US 2022/0111546 A1
(43) Pub. Date: Apr. 14, 2022

(54) DIE PRESS DEVICE INCLUDING A DIE CHASE SYSTEM

(71) Applicant: Phoenix Partners, LLC, Millville, NJ (US)

(72) Inventor: Robert George Weidhaas, SR., Lakeville, PA (US)

(73) Assignee: Phoenix Partners, LLC, Millville, NJ (US)

(21) Appl. No.: 17/065,928

(22) Filed: Oct. 8, 2020

(51) Int. Cl. B26D 7/26; B26F 1/44; B21D 37/12; B26F 1/40

(52) U.S. Cl. CPC B26D 7/2614; B26F 1/44; B26D 2007/2607; B26F 1/40; B26F 2001/4463; B21D 37/12

(57) ABSTRACT

A die press device includes a first platen for receiving installation of a die board comprising dies, a second platen capable of moving between a first position away from the first platen and a second position close to the first platen, a first chase bar and a second chase bar mounted on a surface of the first platen, and a control system for controlling a first movement of the first chase bar and a second movement of the second chase bar.

### TECHNICAL FIELD

This disclosure relates to a die press device, and in particular, to a die press device including a die chase system for safely and efficiently loading and unloading a die board.

### BACKGROUND

Die press devices including clamshell die press devices are often used to cut substrate work pieces, such as cardboards, plastic sheets, corrugated boards etc., into products of different shapes. These products can be used for different commercial purposes. A clamshell die press may include a frame (or base) for supporting a pair of platens made of steel. The pair of platens may include a fixed platen that is secured to the frame, and a moving platen that moves along a track between a fully open (an inoperative) position and a substantially close (an operative) position relative to the fixed platen. The fixed platen may include mounting points at which die or tooling can be mounted. The die or tooling can be the cutting blades that may cut the work pieces placed on the working surface of the moving platen. At the inoperative position, one end of the moving platen is pushed away from the fixed platen to allow an operator to place a work piece on the moving platen. At the operative position, the moving platen is pushed up towards the fixed platen with force to enable the tooling to cut through the work piece, thus forming the products.

Certain models of clamshell die presses, especially those large-format (e.g., 63″×85″, 63″×108″, 63″×123″ formats) die presses, may have a single bottom die chase bar to hold the weight of the die. To mount, attach, and screw the die (or cutting tool) into the die press, the operator may need to climb into the die press to locate, mount and install the die, where the die can be in the form of a die board (a board with dies installed on it). The process to install the die board on to the die press creates safety issues because the operator needs to climb into the die press to fix (e.g., using screws) the die board onto the fixed platen. Further, it may take a long time for the operator to manually install the die board onto the fixed platen, resulting in efficiencies in the operation of the die press device.

### BRIEF DESCRIPTION OF THE DRAWINGS

The present disclosure is illustrated by way of example, and not by way of limitation, in the figures of the accompanying drawings.

FIG. 1 illustrates a die press device including a chase for loading and unloading a die board according to an implementation of the disclosure.

FIG. 2 illustrate a process for loading a die board to a die press device according to an implementation of the disclosure.

FIG. 3 illustrate a process for unloading a die board to a die press device according to an implementation of the disclosure.

### DETAILED DESCRIPTION

Therefore, there is a need for apparatus and method to improve the installation of the die board onto the die press device. Implementations of the disclosure provide a die press device including a chase system that may assist the operator to install a die board onto the die press while eliminating the need for the operator to climb into the die press during the installation.

Implementations of the disclosure may include a die press device. The die press device may include a first platen for receiving installation of a die board that include dies, a second platen capable of moving between a first position away from the first platen and a second position close to the first platen, a first chase bar and a second chase bar mounted on a surface of the first platen, and a control system for independently controlling a first movement of the first chase bar and a second movement of the second chase bar.

In one implementation, the die press device may further include at least one rail mounted on the second platen for receiving a position assembly at a pre-determined position, the position assembly comprising an arm and a pin, where a first end of the arm is removably fixed to the at least one rail, and the pin is fixed to a second end of the arm, and where the pin is pointed to a direction away from the first second platen.

In one implementation, the die press device may further include a motor, and to load the die board on to the die press device, a padding layer is provided on to a surface of the second platen while the second platen is at the first position. The position assembly is mounted along the at least one rail and is removably fixed to the at least one rail at the first end of the arm. The die board is secured to the second platen by the pin through a hole in the die board, wherein the dies on the die board face the padding layer. Responsive to a first control signal, the motor is to drive the second platen from the first position to the second position, forcing the die board against the surface of the first platen at the second position. Responsive to a second control signal, the control system is to control the first movement of the first chase bar and the second movement of the second chase bar to clamp the die board on to the surface of the first platen.

In one implementation, at least one of the chase bars is configured with an electromagnetic element, where responsive to clamping the die board on to the surface of the first platen, the electromagnetic element is magnified to provide a magnetic force to bind the die board to at least one of the first chase bar or the second chase bar.

In one implementation, after securing the die board to the first platen by clamping force generated between the first chase bar and the second chase bar and by magnetic force generated by the electromagnetic element, and responsive to a third control signal, the motor is to drive the second platen from the second position to the first position to allow removal of the position assembly from the at least one rail.

In one implementation, to unload the die board from the first platen, the motor is to drive the second platen to the first position responsive to the third control signal. The position assembly is mounted along the at least one rail and is removably fixed to the at least one rail at the first end of the arm. Responsive to the first control signal, the motor is to drive the second platen from the first position to the second position, causing the pin inserted into the hole in the die board. Responsive to a fourth control signal, the control system is to move the first chase bar and the second chase bar away from the die board to release the die board. Responsive to releasing the die board, the electromagnetic element is de-magnified to remove the magnetic force. Responsive to the third control signal, the motor is to drive the second platen from the second position to the first position to allow removal of the die board and the position assembly from the at least one rail.

In one implementation, the pin comprises a sleeve, where the sleeve is removed from the pin prior to the unloading process.

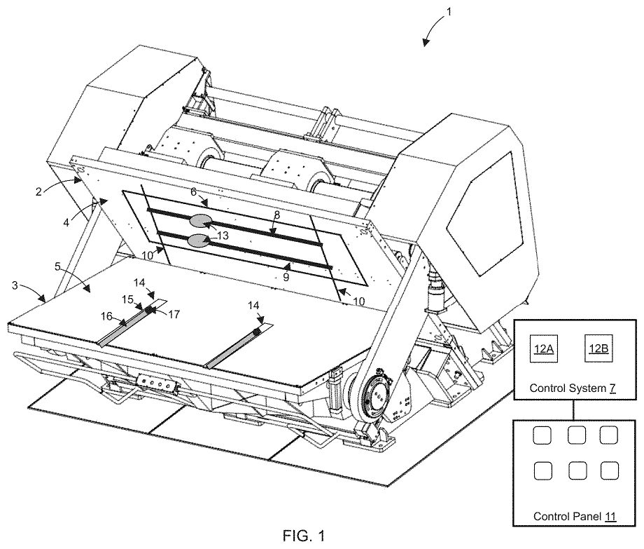

FIG. 1 illustrates a die press device 1 including a chase for loading and unloading a die board according to an implementation of the disclosure. For illustrative purpose, the die press device is shown in the form of a clamshell die press device. While the following description is provided with references to the clamshell die press device, it is understood that implementations of disclosure are applicable to other types of die press devices without limitation.

As shown in FIG. 1, clamshell die press device 1 may include a first platen 2 and a second platen 3, where the first platen 2 is fixed (also referred to as a fixed platen) in the sense that the fixed platen does not move during the normal operation of the die press device, and the second platen is a moving platen that can move from a first open position (as shown in FIG. 1) to a second close position during the normal operation. Each of first platen 2 and second platen 3 may be provided with a substantially flat working surface. First platen 2 may be provided with a working surface 4, and second platen 3 may be provided with a working surface 5. Working surfaces 4 and 5 may face each other in the close position.

At the first open position (as shown in FIG. 1), working surface 5 of the moving platen is away from the working surface 4 of the fixed platen. In this open position, the moving platen is substantially parallel to the ground and a front edge of the moving platen is farthest away the corresponding front edge of the fixed platen. While in the open position, an operator of the die press device may perform certain tasks. A first task of an operator is to place a work piece on working surface 5. Optionally, the operator may first place a padding layer on working surface 5 and then place the work piece on the padding layer. The padding layer may be composed of soft materials to provide a layer of cushion for the dies during the cut to prevent the dies from direct contacts with working surface 5, thus protecting the dies and working surface 5 from wears and damages caused by direct contacts. If a die board is already mounted on working surface 4 of the fixed platen where the die board may be equipped with dies for cutting a work piece into a certain pre-designed pattern, the operator may use a control panel 11 to issue a cut operation instruction which may start a transport mechanism causing the moving platen to move along a track towards the fixed platen. Upon pressing the moving platen against the fixed platen in the close position, the pressing force between the moving platen and the fixed platen may force the dies on the die board to cut through the work piece. After the cut, the operator may use the control panel 11 to issue a release instruction which may reverse the transport mechanism causing the moving platen to move away from the fixed platen. Upon moving back to the open position again, the operator may remove the work product (created by cutting through the work piece) from working surface 5. This process may be repeated to create a large quantity of work products.

While in the open configuration, the operator may also perform the task of installing or uninstalling a die board onto the working surface 4 of the fixed platen. Different types of work products may require different types of die boards which may have different shapes and dimensions. The current practice for installing or uninstalling the die board onto a large-format clamshell die press device may require the operator to climb into the open press machine and manually install the die board onto the working surface 4, for example, by using screws to bolt the die boards into threaded anchor holes. These manual installation and uninstallation processes have safety risks because the operator needs to be physically in-between the fixed platen and the moving platen. Additionally, the manual installation and uninstallation processes may take a long time, causing unnecessary machine down times.

To overcome the above-identified and other deficiencies of current practice and implementations of die press devices, implementations of the disclosure provide a die press device with a chase system that allows easy loading and unloading of the die board onto the fixed platen without the need for the operator to climb into the machine to manually install or uninstall the die board. Referring to FIG. 1, die press device 1 may further include a chase system 6 mounted the fixed platen and a chase control system 7 for controlling chase system 6. Chase system 6 may include one or more mechanical components that may be controlled by the control system to securely mount a die board onto the fixed platen.

In one implementation, chase system 6 may include a first chase bar 8 and a second chase bar 9 mounted on tracks 10 laid on working surface 4 of the fixed platen. First chase bar 8 may be substantially parallel to second chase bar 9. Each of first chase bar 8 and second chase bar 9 may be controlled by control system 7 to move along tracks 10 on working surface 5. The movements of any one or both of chase bars 8 and 9 may cause decrease or increase the distance between first chase bar 8 and second chase 9, thus enabling the clamp or release of a die board using chase bars 8, 9 on working surface 5. Chase bars 8, 9 can be made of a suitable type of material such as a metal, an alloy, or high-density polyethylene (HDPE). Chase bars 8, 9 can be in the shape of a long cylinder having a cross-section of a circle, a half-circle, or a square.

In one implementation, chase bars 8, 9 may be moved along tracks 10. The movements of chase bars 8, 9 may be controlled by control system 7. In one implementation, control system 7 may include a control panel 11 and electric motors 12A, 12B, where an electric motor can be a servomotor, a step motor, or a torque motor. Control panel 11 may include activation elements such as buttons that, when activated, may issue control instructions to drive electric motors 12A, 12B of control system 7. The electric motors 12A, 12B may in turn cause chase bars 8, 9 to move correspondingly along tracks 10. In one implementation, control panel 11 may include a first button that may be used to issue control instructions causing electric motor 12A connected to chase bar 8 to move up or down along tracks 10; control panel 11 may include a second button that may be used to issue control instructions causing electric motor 12B connected to chase bar 9 to move up or down along tracks 10. In this way, chase bars 8 and 9 may be controlled to move individually and independently. The independent movements of chase bars 8 and 9 allow for the clamp of a die board even if the die board is placed a little off center, thus securing the die board even if it is misaligned. Further, the independent moving chase bars 8, 9 may move the die board up or down while in the chase to help balance the load of the die press device.

In addition to chase bars 8, 9 used to secure the die board, implementations of the disclosure may provide further securing elements to bind the die board to the fixed platen. In one implementation, electromagnetic elements are used to bind the die board to the fixed platen. In one implementation, chase bars 8, 9 may include electromagnetic elements 13 that may be electrically activated to produce a magnetic field to bind onto metal elements on the die board. When activated, the magnetic force generated by electromagnetic elements 13 may provide further force to secure die board to the fixed platen. In one implementation, electromagnetic elements 13 can be electromagnetic pieces attached to chase bars 8, 9. In another implementation, chase bars 8, 9 themselves are made of electromagnetic material, and thus parts of chase bars 8, 9 are the electromagnetic element 13.

Implementations of the disclosure may use the moving platen to transport a die board to the fixed platen for its installation. In one implementation, the moving platen may include one or more rails 14 (e.g., two rails). Each rail located at a pre-determined position may receive a corresponding position assembly 15 that may temporarily hold the die board on working surface 5 of the moving platen. Position assembly 15 may include an arm 16 and a pin set 17. Arm 16 may be made from steel with a certain length. A first end of arm 16 is removably fixed onto the moving platen at a first end of rail 14. For example, the first end of arm 16 may include a clip that may be used to removably fix arm 16 onto the moving platen into rail 14. The pin set 17 is fixed to a second end of arm 16. Pin set 17 may include a pin and a sleeve surrounding the pin. For example, the sleeve can be a bushing with threads that can be screwed onto the pin. The sleeve can be removed from the pin to reduce the diameter of the pin set 17. Pin set 17 may be pointed to a direction away from working surface 5 of the moving platen. When arm 16 is mounted into rail 14, pin set 17 may provide a precise position for placing the die board. In one implementation, the moving platen may include two rails 14 that are separated by a certain distance. Each of the two rails 14 may be mounted with a corresponding position assembly 15. These two position assemblies may provide two positioning pin sets that may be used to fix the die board to the moving platen at a pre-determined position.

In one implementation, the moving platen may be driven to the open position which is farthest from the fixed platen. At the open position, working surface 5 of the moving platen may be substantially parallel to the ground. An operator may first place a padding layer on working surface 5. The padding layer may be made of soft materials and may include two longitudinal openings to expose two rails 14. The operator may install two position assemblies 15 in the two corresponding rails 14 through the openings of the padding layer.

Subsequent to mounting the position assemblies 15, the operator may mount a die board onto the moving platen using the two pin sets 17. The die board may be made of wood with dies installed on one side surface of the die board. The die board may include two positioning holes with diameters and distance corresponding to the two pin sets 17. The operator may mount the die board according to the two holes onto the two pin sets 17 of the two position assemblies with the dies facing the soft padding layer to avoid damaging the dies. In one implementation, the two holes are located at an edge of the die board so that when the die board is mounted, the position assemblies 15 do not interfere with the dies thereon.

After mounting the die board onto the position assemblies, the operator may activate a die board loading button on the control panel 7. The activation of the die board loading button may generate a control signal to cause a main motor of the die press device to drive the moving platen (with the die board) from the open position towards the fixed platen. The moving platen may stop at a die board loading position at which the back surface (the one without dies) is against working surface 4 of the fixed platen with just enough pressure applied to the die board to ensure a firm contact between the back surface and working surface 4. The pressure applied may flatten any warping of the die board for a proper installation of the die board.

Once the die press device is driven to the die board loading position, the operator may activate one or more buttons on control panel 11 to issue control instructions to start the clamp operations, where the one or more buttons may include a first button to control electric motor 12A for chase bar 8 and a second button to control electric motor 12B for chase bar 9. The control instructions may cause electric motors 12A, 12B to move chase bars 8, 9 towards each other and eventually, clamp the die board in-between with pressing force from two opposite directions. The clamping by chase bars 8, 9 may hold the die board onto working surface 4 of the fixed platen. Responsive to clamping the die board by chase bars 8, 9, electromagnetic elements 13 that may be electrically activated to produce a magnetic force to bind onto metal elements on the die board, thereby further binding the die board to working surface 4 of the fixed platen. In this way, the die board is securely bound to working surface 4 of the fixed platen without the need for the operator to climb into the die press device.

After the die board is properly installed onto the fixed platen, the operator may activate a retreat button that may generate control signals to the main motor that may cause reverse the moving platen without the die board back to its open position. Once the moving platen is at its open position, the operator may remove the position assemblies 15. The die press device 1 is ready for normal operation of cutting work pieces.

The operator may operate the die press device 1 to cut work pieces into work products. When there is a need to install a new die board to work on a different type of products, the operator may first uninstall the existing die board on the fixed platen. To unload or remove the die board installed on the fixed platen of the die press device 1, the operator may first replace the position assemblies 15 in rails 14. In the unloading operation, the operator may remove the sleeve from pin set 17. The removal of the sleeve may allow the pin to be inserted into the holes in the die board even if there is a slight shift of the die board caused during the normal operation. After mounting position assemblies 15, the operator may activate the die board loading button on control panel 7. The activation of the die board loading button may generate a control signal to cause a main motor of the die press device to drive the moving platen (without the die board) from the open position to the loading position. At the loading position, the pins on position assemblies 15 may be inserted into the holes on the die board. The operator may then activate the first and/or second buttons to unclamp chase bars 8, 9 from the die board. Responsive to the unclamping, the electromagnetic elements 13 may be de-magnified to remove the magnetic force that binds the die board to the fixed platen. In this way, the die board is free from forces attaching to the fixed platen and is away from the fixed platen into the pin. The operator may then activate the retrieve button that may generate control signals to the main motor that may cause reverse the moving platen with the die board back to its open position. Once the moving platen is at its open position, the operator may remove the die board. The die press device 1 is ready for the installation of the new die board. As such, the die board can be installed and uninstalled using the position assemblies 15, chase bars 8, 9, and the control system 7, thereby eliminating the need for the operator to climb into the die press device.

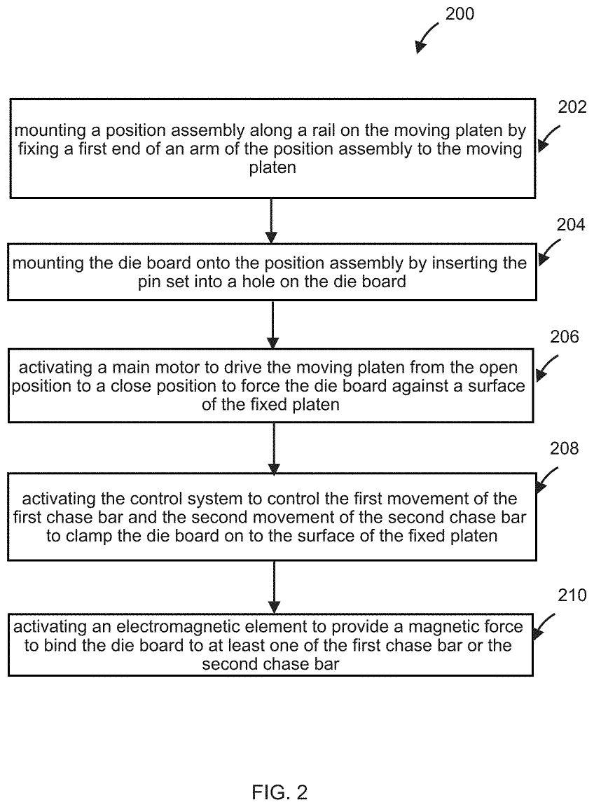

FIG. 2 illustrate a process 200 for installing a die board to a die press device according to an implementation of the disclosure. As discussed above, a die press may be a clamshell die press including a fixed platen and a moving platen, first and second chase bars mounted on a working surface of the fixed platen, and a control system to control movements of the first and second chase bars.

While the die press device is in an open position, at 202, an operator may mount a position assembly along a rail on the moving platen by fixing a first end of an arm of the position assembly to the moving platen, where a second end of the arm is provided with a pin set.

At 204, the operator may mount the die board onto the position assembly by inserting the pin set into a hole on the die board, where dies on the die board face the padding layer.

At 206, a main motor of the die press device is activated to drive the moving platen from the open position to a close position to force the die board against a surface of the fixed platen.

At 208, the control system is activated to control a first movement of the first chase bar and a second movement of the second chase bar to clamp the die board on to the surface of the fixed platen.

At 210, an electromagnetic element attached to at least one of the first chase bar or the second chase bar is activated to provide a magnetic force to bind the die board to at least one of the first chase bar or the second chase bar.

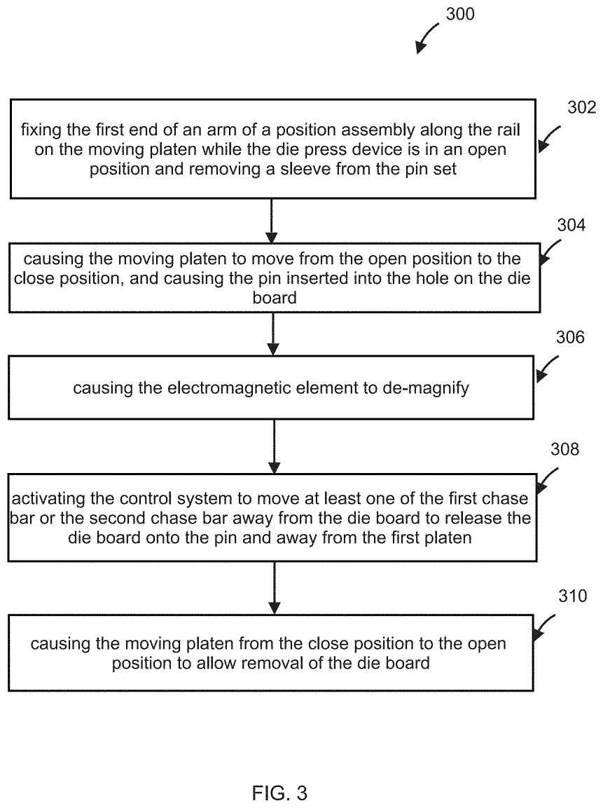

FIG. 3 illustrate a process 300 for uninstalling a die board to a die press device according to an implementation of the disclosure.

While at the open position, at 302, the operator may fix the first end of an arm of a position assembly along the rail on the moving platen while the die press device is in an open position and removing a sleeve from the pin set.

At 304, the moving platen is controlled to move from the open position to the close position, and causing the pin inserted into the hole on the die board.

At 306, the electromagnetic element is de-magnify so that the die board is not bound to the first chase bar or the second chase bar by the magnetic force.

At 308, the control system is activated to move at least one of the first chase bar or the second chase bar away from the die board to release the die board onto the pin and away from the first platen.

At 310, the moving platen is controlled to move from the close position to the open position to allow removal of the die board.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “an embodiment” or “an implementation” or “one implementation” throughout is not intended to mean the same embodiment or implementation unless described as such.

Reference throughout this specification to “an embodiment” or “an embodiment” means that a particular feature, structure, or characteristic described in connection with the embodiment is included in at least an embodiment. Thus, the appearance of the phrases “in an embodiment” or “in an embodiment” in various places throughout this specification are not necessarily all referring to the same embodiment. In addition, the term “or” is intended to mean an inclusive “or” rather than an exclusive “or.”

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A die press device, comprising:
a first platen for receiving installation of a die board comprising dies;
a second platen capable of moving between a first position away from the first platen and a second position close to the first platen;
a first chase bar and a second chase bar mounted on a surface of the first platen; and
a control system for controlling a first movement of the first chase bar and a second movement of the second chase bar.

2. The die press device of claim 1, further comprising:
at least one rail mounted on the second platen for receiving a position assembly at a pre-determined position, the position assembly comprising an arm and a pin set, wherein a first end of the arm is removably fixed to the at least one rail, and the pin set is fixed to a second end of the arm, and wherein the pin set is pointed to a direction away from the first second platen.

3. The die press device of claim 2, further comprising a motor,
wherein to load the die board on to the die press device, a padding layer is provided on to a surface of the second platen while the second platen is at the first position,
the position assembly is mounted along the at least one rail and is removably fixed to the at least one rail at the first end of the arm,
the die board is secured to the second platen by inserting the pin set through a hole in the die board, wherein the dies on the die board face toward the padding layer,
responsive to a first control signal, the motor is to drive the second platen from the first position to the second position, forcing the die board against the surface of the first platen at the second position, and
responsive to a second control signal, the control system is to control a first electric motor to drive the first movement of the first chase bar and to control a second electric motor to drive the second movement of the second chase bar to clamp the die board on to the surface of the first platen.

4. The die press device of claim 3, wherein the padding layer the padding layer comprises at least one of Urethane, rubber, or ultra-high-molecular-weight (UHMW) polyethylene.

5. The die press device of claim 3, wherein at least one of the first chase bar or the second chase bar is configured with an electromagnetic element, and wherein responsive to clamping the die board on to the surface of the first platen, the electromagnetic element is magnified to provide a magnetic force to bind the die board to the first platen.

6. The die press device of claim 5, wherein after securing the die board to the first platen by clamping force generated between the first chase bar and the second chase bar and by magnetic force generated by the electromagnetic element, and responsive to a third control signal, the motor is to drive the second platen from the second position to the first position to allow removal of the position assembly from the at least one rail.

7. The die press device of claim 6, wherein to unload the die board from the first platen, the motor is controlled to drive the second platen to the first position responsive to the third control signal,
the position assembly is mounted along the at least one rail and is removably fixed to the at least one rail at the first end of the arm,
responsive to the first control signal, the motor is to drive the second platen from the first position to the second position, causing the pin set inserted into the hole on the die board,
responsive to a fourth control signal, the control system is to move the first chase bar and the second chase bar away from the die board to release the die board onto the pin;
responsive to releasing the die board, the electromagnetic element is de-magnified to remove the magnetic force; and
responsive to the third control signal, the motor is to drive the second platen from the second position to the first position to allow removal of the die board and the position assembly from the at least one rail.

8. The die press device of claim 6, wherein the pin set comprises a pin and a sleeve, and wherein the sleeve is removed from the pin set prior to unloading process.

9. The die press device of claim 2, wherein the at least one rail comprises two rails, and wherein each of the two rails is to receive a corresponding one position arm assembly.

10. The die press device of claim 1, wherein the die press device is a clamshell die press device.

11. The die press device of claim 10, wherein the clamshell die press device is configured with a first dimension of at least 65 inches and a second dimension of at least 85 inches.

12. A method for installing and uninstalling a die board onto a die press machine, wherein the die press device comprises a fixed platen, a moving platen, a first chase bar and a second chase bar mounted on a surface of the fixed platen, and a control system for controlling a first movement of the first chase bar and a second movement of the second chase bar, the method comprising:
while the die press device is in an open position, mounting a position assembly along a rail on the moving platen by fixing a first end of an arm of the position assembly to the moving platen, wherein a second end of the arm is provided with a pin set pointing to a direction opposite to the moving platen;
mounting the die board onto the position assembly by inserting the pin set into a hole on the die board, wherein dies on the die board face toward the moving platen;
activating a main motor to drive the moving platen from the open position to a close position to force the die board against a surface of the fixed platen; and
activating the control system to control the first movement of the first chase bar and the second movement of the second chase bar to clamp the die board on to the surface of the fixed platen.

13. The method of claim 12, further comprising:
activating an electromagnetic element attached to at least one of the first chase bar or the second chase bar to provide a magnetic force to bind the die board to the fixed platen.

14. The method of claim 13, further comprising:
unmounting the position assembly; and
operating the die press device to cut work pieces into work products.

15. The method of claim 14, further comprising:
causing the motor to drive the moving platen to the open position;
fixing the first end of an arm of a position assembly along the rail on the moving platen while the die press device is in an open position and removing a sleeve from the pin set;
causing the moving platen to move from the open position to the close position, and causing the pin inserted into the hole on the die board;
activating the control system to move the first chase bar and the second chase bar away from the die board to release the die board;
causing the electromagnetic element to de-magnify; and
causing the moving platen from the close position to the open position to allow removal of the die board.

16. A die press device, comprising:
a first platen for receiving installation of a die board comprising dies;
a second platen capable of moving from an open position to a close position;
a chase system mounted on a surface of the first platen; and
a control system that responsive to a control signal generated by activating an activation element on a control panel, controls the chase system to clamp onto the die board on the first platen.

17. The die press device of claim 16, further comprising:
at least one rail mounted on the second platen for receiving a position assembly at a pre-determined position, the position assembly comprising an arm and a pin set, wherein a first end of the arm is removably fixed to the at least one rail, and the pin set is fixed to a second end of the arm, and wherein the pin set is pointed to a direction away from the first second platen.

18. The press device of claim 17, further comprising a motor,
wherein to load the die board on to the die press device, a padding layer is provided on to a surface of the second platen while the second platen is at the open position,
the position assembly is mounted along the at least one rail and is removably fixed to the at least one rail at the first end of the arm,
the die board is secured to the second platen by inserting the pin set through a hole in the die board, wherein the dies on the die board face the padding layer,
responsive to a first control signal, the motor is to drive the second platen from the first position to the second position, forcing the die board against the surface of the first platen at the second position, and
responsive to a second control signal, the control system is to control a first electric motor to drive the first movement of the first chase bar and to control a second electric motor to drive the second movement of the second chase bar to clamp the die board on to the surface of the first platen.

19. The die press device of claim 18, wherein the chase system is configured with an electromagnetic element, and wherein responsive to clamping the die board on to the surface of the first platen, the electromagnetic element is magnified to provide a magnetic force to bind the die board to the first platen.

20. The die press device of claim 19, wherein the die press device is a clamshell die press device, and wherein the chase system comprises a first chase bar and a second chase bar that are substantially parallel to each other, and a movement of each of the first chase bar and the second chase bar is individually controlled by the control system.
